(19) United States
(12) Patent Application Publication
(10) Pub. No.: US 2026/0127791 A1
(43) Pub. Date: May 7, 2026

(54) IMAGE PROCESSING DEVICE, IMAGING APPARATUS, AND IMAGE PROCESSING METHOD

(71) Applicant: Panasonic Intellectual Property Management Co., Ltd., Osaka (JP)

(72) Inventor: Koji ISHII, Osaka (JP)

(73) Assignee: Panasonic Intellectual Property Management Co., Ltd., Osaka (JP)

(21) Appl. No.: 19/376,907

(22) Filed: Nov. 1, 2025

(30) Foreign Application Priority Data
Nov. 7, 2024 (JP) 2024-195104

(51) Int. Cl. G06T 11/60; G06T 5/90; G06T 7/50

(52) U.S. Cl. CPC G06T 11/60; G06T 5/90; G06T 7/50

(57) ABSTRACT

An image processing device includes: an input interface configured to input a first image data indicating a subject image shot by an imaging apparatus; and a controller configured to generate composite image data, based on the first image data input on the input interface and second image data indicating a predetermined background image, the composite image data synthesized from the subject image and the background image. The controller is configured to: obtain light source information, based on the second image data, the light source information indicating light source in the background image; and generate the composite image data to include a shadow area into a composite image in which the subject image is placed on the background image, based on the light source information on the background image, the shadow area showing a shadow corresponding to a subject indicated by the subject image in accordance with the light source.

### TECHNICAL FIELD

The present disclosure relates to an image processing device for synthesizing images, an imaging apparatus, and an image processing method.

### BACKGROUND ART

JP 2019-101978 A discloses an image processing device that adds shade effects created by virtual lighting to captured images. This image processing device extracts 3D shape data of the subject area from 3D shape data corresponding to the captured image. When the 3D shape data of the subject area has missing parts, the device sets the movable range of the virtual lighting based on the missing parts of the 3D shape data. This ensures that when generating an image that reproduces shades under virtual lighting conditions based on the 3D shape data of the subject, unnatural shades are not reproduced.

In recent years, image synthesis technology has been developed that replaces the background of photographs containing subjects such as people with other images. In simple synthesis, the lighting of the subject appears unnatural, so re-lighting technology has been proposed that reflects the lighting appropriate for the new background onto the subject image through image processing (e.g., Documents 1-2).
Document 1: Rohit Pandey, et al, “Total Relighting: Learning to Relight Portraits for Background Replacement,” ACM Transactions on Graphics, Vol. 40, No. 4, 2021.
Document 2: Daichi Tajima, et al, “Relighting Humans in the Wild: Monocular Full-Body Human Relighting with Domain Adaptation,” Computer Graphics Forum (Proc. of Pacific Graphics 2021), Vol. 40, No. 7, 2021.

### SUMMARY

The present disclosure provides an image processing device, an imaging apparatus, and an image processing method that can facilitate producing natural shadows in image synthesis between a shot subject and a background.

In the present disclosure, an image processing device includes: an input interface configured to input a first image data indicating a subject image shot by an imaging apparatus; and a controller configured to generate composite image data, based on the first image data input on the input interface and second image data indicating a predetermined background image, the composite image data synthesized from the subject image and the background image. The controller is configured to: obtain light source information, based on the second image data, the light source information indicating light source in the background image; and generate the composite image data to include a shadow area into a composite image in which the subject image is placed on the background image, based on the light source information on the background image, the shadow area showing a shadow corresponding to a subject indicated by the subject image in accordance with the light source.

In the present disclosure, an imaging apparatus includes: an image sensor configured to capture an image of the subject to generate the first image data, and the image processing device configured to generate the composite image data, based on the first image data generated by the image sensor.

In the present disclosure, an image processing method is executed by a computer. The method includes: inputting first image data indicating subject image shot by an imaging apparatus, and obtaining light source information, based on second image data indicating a predetermined background image, the light source information indicating light source in the background image, and generating composite image data to include a shadow area into a composite image in which the subject image is placed on the background image, based on the light source information on the background image, the composite image data synthesized from the subject image and the background image, the shadow area showing a shadow corresponding to a subject indicated by the subject image in accordance with the light source.

According to the image processing device, imaging apparatus, and image processing method disclosed herein, it is possible to facilitate producing natural shadows in the image synthesis of the shot subject and background.

### BRIEF DESCRIPTION OF DRAWINGS

FIG. 1 is a diagram illustrating configuration of an imaging system in a first embodiment of the present disclosure;

FIG. 2 is a diagram showing configuration of a digital camera in the imaging system;

FIG. 3 is a diagram showing configuration of an image editing terminal in the imaging system;

FIGS. 4A to 4C are diagrams explaining operation of the imaging system;

FIG. 5 is a flowchart illustrating operation of the image editing terminal in the imaging system of the first embodiment;

FIG. 6 is a flowchart illustrating background preparation processing in the imaging system;

FIGS. 7A to 7C are diagrams explaining the background preparation processing in the imaging system;

FIG. 8 is a diagram explaining background environment in the imaging system;

FIG. 9 is a flowchart illustrating image synthesis processing in the imaging system;

FIGS. 10A to 10D are diagrams explaining the image synthesis processing in the imaging system;

FIG. 11 is a flowchart illustrating shadow correction processing in the imaging system;

FIG. 12 is a diagram explaining the shadow correction processing in the imaging system; and

FIG. 13 is a flowchart illustrating operation of an imaging system in a modified example.

### DETAILED DESCRIPTION

Hereinafter, embodiments of the present disclosure will be described with reference to the relevant drawings. However, in the detailed description, unnecessary portions of the description relating to the prior art and the substantially identical configuration may be omitted. This is to simplify the description. The following description and the accompanying drawings are disclosed to enable those skilled in the art to fully understand the present disclosure and are not intended to limit the subject matter of the claims.

### First Embodiment

### 1. Configuration

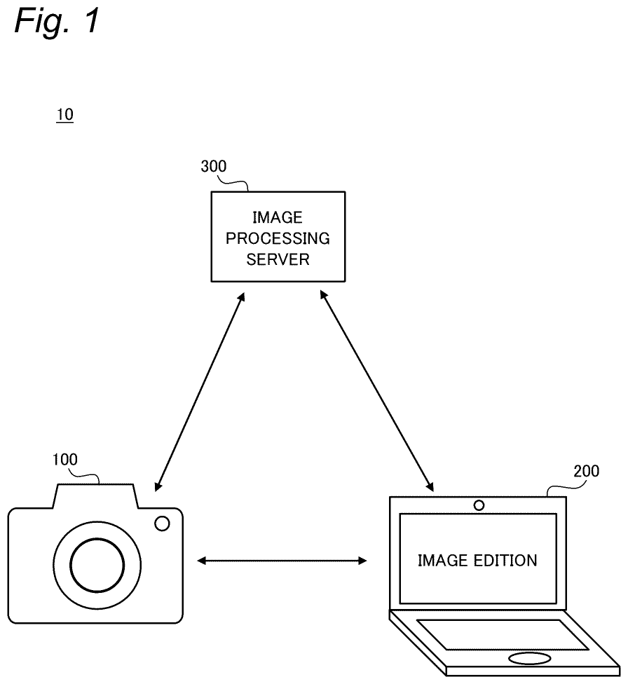

An imaging system in the first embodiment of the present disclosure will be described with reference to FIG. 1.

The present system 10 includes, for example as shown in FIG. 1, a digital camera 100, an image editing terminal 200, and an image processing server 300. In the present system 10, the digital camera 100 and the image editing terminal 200 are connected so as to be capable of data communication via wired communication or wireless communication, for example. The image processing server 300 is connected to the digital camera 100 and the image editing terminal 200 via a communication network such as the Internet.

For example, the present system 10 is applicable to applications in which a user shoots and edits video or still images using the digital camera 100, and is applicable, for example, to virtual production that uses image synthesis instead of large-scale studio equipment. In the present system 10, for example, a live view image from the digital camera 100 can be viewed on the image editing terminal 200.

The image editing terminal 200 is an information terminal for editing image data obtained from the digital camera 100, for example. In the present system 10, the image editing terminal 200 may or may not be connected to the digital camera 100 and image processing server 300. For example, data from the digital camera 100 may be input to image editing terminal 200 via a portable recording medium such as a memory card.

The image processing server 300 is a server device composed of various computers, such as a cloud server. For example, the image processing server 300 can perform various image processing operations in the present system 10 as appropriate. For example, the image processing server 300 is equipped with a processor such as a CPU or GPU, memory such as ROM or RAM, and various input/output interfaces. The present system 10 may not include the image processing server 300.

### 1.1. Components of a Digital Camera

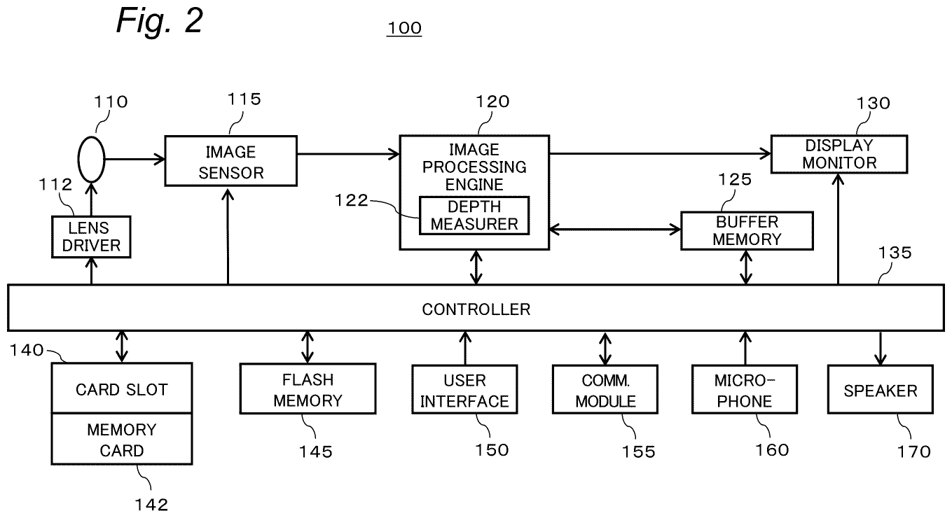

The configuration of the digital camera 100 in the present embodiment will be explained with reference to FIG. 2.

FIG. 2 is an example of the configuration of the digital camera 100 in the present system 10. The digital camera 100 is an example of an imaging apparatus in the present embodiment. The digital camera 100 of the present embodiment includes an image sensor 115, an image processing engine 120, a display monitor 130, and a controller 135. Furthermore, the digital camera 100 includes a buffer memory 125, a card slot 140, a flash memory 145, a user interface 150, a communication module 155, a microphone 160, and a speaker 170. Additionally, the digital camera 100 includes, for example, an optical system 110 and a lens driver 112.

The optical system 110 includes a focus lens, a zoom lens, an optical image stabilization lens (OIS), an aperture stop, a shutter, and the like. The focus lens is a lens for changing the focus state of the image of the subject formed on image sensor 115. The zoom lens is a lens for changing the magnification of the image of the subject formed by the optical system. The focus lens and other components are each composed of one or more lenses.

The lens driver 112 drives the focus lens and others in the optical system 110. The lens driver 112 includes a motor and moves the focus lens along the optical axis of the optical system 110, based on control from the controller 135. The configuration for driving the focus lens in the lens driver 112 can be realized using a DC motor, a stepping motor, a servo motor, or an ultrasonic motor.

The image sensor 115 captures an image of the subject formed through optical system 110 to generate image data. The image data constitutes image data indicating the image captured by image sensor 115. Image sensor 115 generates image data for a new frame at a predetermined frame rate (e.g., 30 frames per second). The timing of image data generation and electronic shutter operation in the image sensor 115 are controlled by the controller 135. The image sensor 115 may use various image sensors, such as a CMOS image sensor, a CCD image sensor, or an NMOS image sensor.

The image sensor 115 performs image capture operations for still images, image capture operations for through images, and so on. Through images are mainly moving images and are displayed on display monitor 130 to allow the user to determine the composition for capturing still images. Through images and still images are examples of captured images in the present embodiment. Image sensor 115 is an example of an image sensor in the present embodiment.

The digital camera 100 of the present embodiment may have a phase difference ranging function. For example, the image sensor 115 may include sensor pixels that constitute phase difference ranging points. For example, the sensor pixels may include a photoelectric conversion section that is divided so as to form two optical images split by the optical system 110. Such sensor pixels may be provided as light-shielding pixels separate from the pixels for RGB images on the image sensor 115, or may be shared with the pixels for RGB images.

The image processing engine 120 performs various processes on the image data output from the image sensor 115 to generate image data, or performs various processes on the image data to generate images for display on the display monitor 130. Examples of such processes include white balance correction, gamma correction, YC conversion processing, electronic zoom processing, compression processing, and expansion processing, but are not limited to these. The image processing engine 120 may be configured using hardwired electronic circuits or using a microcomputer, processor, or other device employing a program.

In the present embodiment, the image processing engine 120 includes a depth measurer 122 that realizes a ranging function using, for example, an image plane phase difference method. The depth measurer 122 performs image plane phase difference ranging based on sensor signals input from sensor pixels in the image sensor 115, and generates a depth map that shows the depth from the digital camera 100 to the subject in the captured image on a per-pixel basis. Phase-difference-based ranging can be performed, for example, by calculating the amount of defocusing corresponding to the difference between two optical images obtained by pupil division from the sensor signals for each ranging point detected by the sensor pixels.

The depth measurer 122 is not limited to the image plane phase difference method. In this case, the image sensor 115 of the digital camera 100 does not necessarily need to be equipped with sensor pixels for the image plane phase difference method. For example, the depth measurer 122 may generate a depth map by performing DFD (Depth From Defocus) calculations based on differences in blur between frames. Alternatively, the depth measurer 122 may employ various depth measurement methods, such as the Time Of Flight (TOF) method, range finder, stereo vision, color-based depth measurement, or depth estimation using artificial intelligence such as machine learning.

Display monitor 130 is an example of a display that displays various information. For example, display monitor 130 displays an image (through image) shown by image data that is captured by image sensor 115 and processed by image processing engine 120. Additionally, the display monitor 130 displays menu screens or the like, for the user to perform various settings on the digital camera 100. The display monitor 130 may be configured, for example, as a liquid crystal display device or an organic EL device.

The user interface 150 is a general term for hard keys such as operation buttons and operation levers provided on the exterior of the digital camera 100, as well as user interfaces, and accepts operations by the user. The user interface 150 includes, for example, a release button, a mode dial, and a touch panel. When the user interface 150 accepts an operation by the user, it transmits an operation signal corresponding to the user operation to the controller 135.

The controller 135 controls the overall operation of the digital camera 100. The controller 135 includes a CPU and others, to realize predetermined functions by executing a program (software) with the CPU. The controller 135 may include a processor composed of dedicated electronic circuits designed to realize predetermined functions in place of the CPU. In other words, the controller 135 may be realized using various processors such as a CPU, MPU, GPU, DSP, FPGA, or ASIC. The controller 135 may be one or more processors. Additionally, the controller 135 may be integrated into a single semiconductor chip along with the image processing engine 120.

The buffer memory 125 is a recording medium that functions as a work memory for the image processing engine 120 and the controller 135. The buffer memory 125 is realized by DRAM (Dynamic Random Access Memory) or the like. The flash memory 145 is a non-volatile recording medium. Additionally, although not shown in the figure, the controller 135 may include various internal memories, such as an internal ROM. The ROM stores various programs executed by the controller 135. Furthermore, the controller 135 may include RAM that functions as the CPU's working area.

The card slot 140 is a means for inserting a removable memory card 142. The card slot 140 is capable of electrically and mechanically connecting the memory card 142. The memory card 142 is an external memory equipped with recording elements such as flash memory. The memory card 142 is capable of storing data such as image data generated by image processing engine 120.

The communication module 155 is a module (circuit) that connects to external devices in accordance with a predetermined communication standard for wired or wireless communication. For example, the predetermined communication standards include USB, HDMI (registered trademark), IEEE 802.11, Wi-Fi, Bluetooth, or the like. The digital camera 100 can communicate with other devices via communication module 155.

The microphone 160 includes one or more microphone elements, for example, those built into digital camera 100. The microphone 160 outputs an audio signal indicating the received audio to controller 135. In the digital camera 100, an external microphone may be used. The digital camera 100 may be provided with a connection port or the like for connecting to the external microphone alternatively or additionally to the built-in microphone 160.

The speaker 170 includes one or more speaker elements built into, for example, the digital camera 100, and outputs sound to the outside of digital camera 100 under control from controller 135. In the digital camera 100, external speakers or earphones may also be used. The digital camera 100 may also include a connection port for connecting to the external speakers or the like, alternatively or additionally to the built-in speaker 170.

### 1.2. Image Editing Terminal Configuration

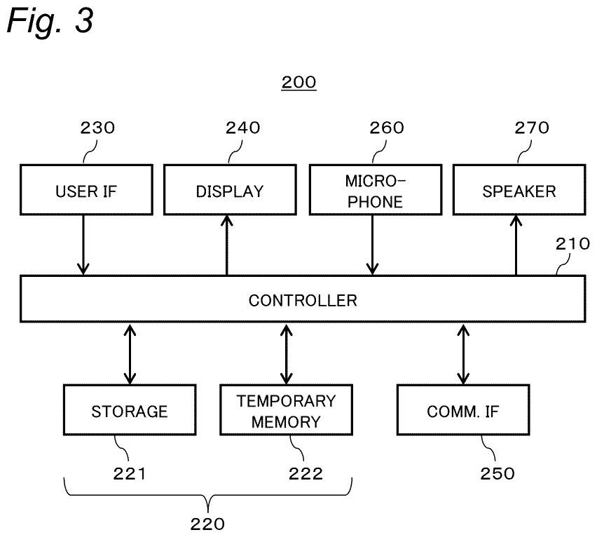

The configuration of the image editing terminal 200 in the present embodiment will be explained with reference to FIG. 3.

FIG. 3 is an example diagram showing the configuration of image editing terminal 200. The image editing terminal 200 is an example of an image processing device that may be configured as a personal computer (PC), a tablet device, or a smartphone, for example. The image editing terminal 200 shown in FIG. 3 includes a controller 210, a memory 220, a user interface 230, a display 240, a communication interface 250, a microphone 260, and a speaker 270.

For example, the controller 210 includes a CPU or MPU that works in cooperation with software to perform predetermined functions. The controller 210 controls the overall operation of the image editing terminal 200, for example. The controller 210 reads data and programs stored in the memory 220, performs various arithmetic operations, and realizes various functions.

The controller 210 executes a program containing a set of instructions for realizing the above functions. The above program may be provided from a communication network such as the Internet, or may be stored on a portable recording medium. Additionally, the controller 210 may be a hardware circuit, such as a dedicated electronic circuit or a reconfigurable electronic circuit, designed to implement the above functions. The controller 210 may be composed of various semiconductor integrated circuits, such as a CPU, MPU, GPU, GPGPU, TPU, microcontroller, DSP, FPGA, and ASIC.

The memory 220 is a storage medium that stores programs and data necessary for realizing the functions of the image editing terminal 200. The memory 220 includes a storage section 221 and a temporary memory 222, as shown in FIG. 3.

The storage 221 stores parameters, data, control programs, and others for performing predetermined functions. For example, the storage 221 is configured by an HDD or SSD. For example, the storage 221 stores the above programs and various image data.

The temporary memory 222 is configured with RAM, such as DRAM or SRAM, and temporarily stores (i.e., holds) data. For example, the temporary memory 222 holds image data that is being edited. The temporary memory 222 may also function as a work area for the controller 210 and may be configured as a storage area in the internal memory of the controller 210.

The user interface 230 is a general term for the operation components that the user operates. For example, the user interface 230 is a touch panel that is superimposed on the display 240 and inputs various touch operations, and is an example of the input interface of the image editing terminal 200. The input interface may also be connection software that communicates with various external input devices to receive operation signals. The user interface 230 may be physical buttons or switches provided on the image editing terminal 200, or may use a keyboard, mouse, or touchpad. The user interface 230 may also be various GUI elements such as virtual buttons, icons, cursors, software keyboards, or objects displayed on the display 240.

The display 240 is configured by an LCD display or an OLED display, for example. The display 240 may display various information, such as various GUIs for operating the user interface 230 and information input from the user interface 230.

The communication interface 250 is a module (circuit) that connects to external devices in accordance with predetermined communication standards for wired or wireless communication. For example, the predetermined communication standards include USB, HDMI, IEEE 802.11, Wi-Fi, Bluetooth, or the like. The communication interface 250 may connect the image editing terminal 200 to a communication network such as the Internet. The communication interface 250 is an example of an input interface that receives various information from external devices or communication networks.

The microphone 260 includes one or more microphone elements built into the image editing terminal 200. The microphone 260 outputs an audio signal indicating the received audio to controller 210. The image editing terminal 200 may also have a connection port or other connection means for connecting to an external microphone alternatively or additionally to the built-in microphone 260.

The speaker 270 includes one or more speaker elements built into, for example, the image editing terminal 200, and outputs audio to the outside of image editing terminal 200 based on control from the controller 210. The image editing terminal 200 may also include a connection section for connecting to an external speaker or earphones, or the like, alternatively or additionally to the built-in speaker 270.

The configuration of the image editing terminal 200 described above is an example, and the configuration of the image editing terminal 200 is not limited to this. For example, various display devices such as a projector and a head-mounted display may be used for the display 240 of the image editing terminal 200. Additionally, for example, when using an external display device, the display 240 of the image editing terminal 200 may be an output interface circuit compliant with, for example, the HDMI standard or the like.

### 2. Operation

The operation of the imaging system 10 configured as described above will be explained below.

### 2.1. Overview of Operation

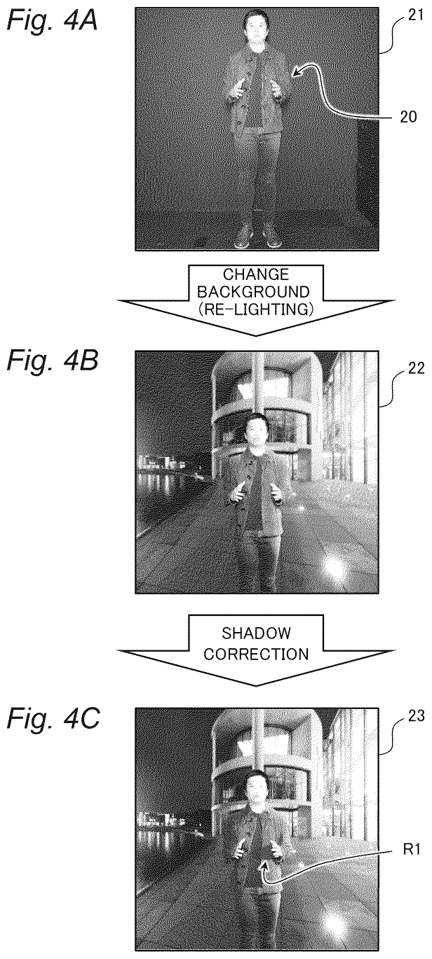

The operation of the imaging system 10 of the present embodiment will be described with reference to FIGS. 4A to 4C.

FIG. 4A illustrates an example of an image 21 shot by the digital camera 100 of the present system 10. The shot image 21 illustrated in FIG. 4A shows a subject 20, such as a person, in the shooting environment of the digital camera 100. The imaging system 10 of the present embodiment performs image synthesis to change the background of the subject 20 in the shot image 21 using the image editing terminal 200 when a user shoots a video or still image of a desired subject 20 using the digital camera 100. Note that the subject 20 in the present system 10 is not limited to a person and may appropriately adopt various subjects as needed.

FIG. 4B shows an example of a composite image 23 based on the shot image 21 in FIG. 4A. In the composite image 23 shown in FIG. 4B, the background has been replaced from FIG. 4A, and the lighting of the subject 20 has been changed by relighting to match the new background. The present system 10 provides a solution to the problems of conventional techniques identified by the inventors, such as re-lighting in image synthesis. First, the inventors' findings will be explained.

The conventional re-lighting techniques (e.g., Documents 1 to 2) can reproduce the reflection of light on the surface of subject 20 by formalizing information such as the uneven surface shape of subject 20. Whereas such techniques can reproduce shading effects where brightness gradually decreases on the surface, the conventional re-lighting techniques struggle to reproduce shadows formed by light obstruction (e.g., self-shadows of subject 20), resulting in unnatural artifacts. This issue has been identified through the inventors' thorough investigation.

Therefore, the inventors has conducted intensive studies to address the issue of the conventional re-lighting technologies, and then, arrived at the imaging system 10 of the present embodiment. The processing results obtained by the present system 10 are illustrated in FIG. 4C.

FIG. 4C illustrates a composite image 23 of the correction results in FIG. 4B in the present system 10. The present system 10 performs a correction that adds a shadow region R1 indicating shadows caused by light from light sources in the background being blocked to the re-lit composite image 22, for example (FIG. 4B). As a result, in the examples of FIGS. 4B and 4C, the shadow region R1 caused by the left arm of the subject 20 is not reproduced in the relit composite image 22 (FIG. 4B), but is reproduced in the corrected composite image 23 as shown in FIG. 4C, for example.

As described above, the present system 10 can supplement shadow expressions that are difficult to reproduce with the conventional re-lighting technologies, and improve the natural appearance of image synthesis compared to the conventional technologies. The following describes the operation of the present system 10 in detail.

### 2.2. Details of Operation

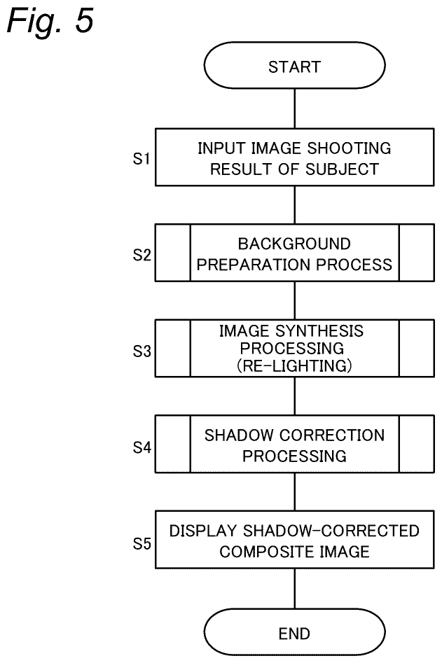

The overall operation of the imaging system 10 of the present embodiment will be described with reference to FIG. 5.

FIG. 5 is a flowchart illustrating the operation of the image editing terminal 200 in the present system 10. Each process in the flowchart shown in FIG. 5 is executed by the controller 210 of the image editing terminal 200, for example.

In the present system 10, the controller 210 of the image editing terminal 200 inputs image data indicating the result of image shooting of the subject 20 by the digital camera 100, for example (S1). For example, using data communication between the digital camera 100 and the image editing terminal 200, the controller 210 receives the image data indicating the shot image 21 from the digital camera 100 via the communication interface 250 (S1).

In the digital camera 100, the controller 135 performs imaging operations such as causing the image sensor 115 to capture an image of a subject in response to user operation, and generates image data of the shooting result based on the captured image data and supplies it to image processing engine 120. For example, the image processing engine 120 functions as a depth measurer 122 to generate a depth map containing the depth of various positions in the image indicated by the imaging data, and includes this depth map into the metadata of the image data of the shooting result. For example, in step S1, the controller 135 transmits the image data of the captured image to the image editing terminal 200 via the communication module 155. The image data of the shot image 21 is an example of the first image data in the present embodiment. The depth map of the digital camera 100 may be managed in association with the image data of the captured image in various ways, not limited to the meta information.

In addition, the controller 210 performs processing to prepare an image (i.e., background image) that is to be a new background in image synthesis (S2). The background preparation processing (S2) of the present embodiment also obtains information on light sources in the new background environment. Details of the processing in step S2 will be described later.

Next, the controller 210 generates a composite image 22, for example as shown in FIG. 4B, based on the image data obtained in steps S1 and S2 (S3). The image synthesis process (S3) of the present embodiment can efficiently perform re-lighting image processing in addition to replacing the background of the shot image 21 (FIG. 4A). Details of the processing in step S3 will be described later.

Next, the controller 210 corrects (or retouches) the composite image 22 to reflect shadows corresponding to light sources in the new background environment (S4). The shadow correction process (S4) of the present embodiment draws the shadow region R1 on the composite image 22 as shown in FIG. 4C, using the information on light sources in the new background environment and the depth map obtained at the image shooting by the digital camera 100. Details of the processing in step S4 will be described later.

Next, the controller 210 displays the shadow-corrected composite image 23 (FIG. 4C) on the display 240, for example (S5). The controller 210 terminates the processing shown in the flowchart of FIG. 5 after performing the shadow correction in step S5, for example.

According to the above processing, the present system 10 can facilitate achieving a natural appearance of the subject 20 in the synthesized image 23, by performing shadow correction processing (S4) that makes the shadow area R1 included therein, in addition to re-lighting in the image synthesis processing (S3). With the shadow correction processing (S4) in the present system 10 performed for reproducing the shadows of the subject 10, the image synthesis processing (S4) can utilize a re-lighting technique with reduced processing load, for example.

The above processing of the present system 10 may be performed in real time in the shooting of a video or still image by the digital camera 100, for example, upon receiving data from the digital camera 100 (S1), or may be performed after the completion of such image shooting.

The processing in step S1 is not limited to the data communication between the digital camera 100 and the image editing terminal 200, but may also be performed by data communication with various external storage devices. For example, the user may input image data of the shooting results of the digital camera 100 into the image editing terminal 200 via a recording medium such as the memory card 142, or via the image processing server 300, or the like.

In addition, The present system 10 may perform various outputs on the shadow-corrected image data in step S4 additionally or alternatively to step S5. For example, the controller 210 may store the corrected image data in the memory 220 or distribute it via the communication interface 250.

### 2.2.1. Background Preparation Process

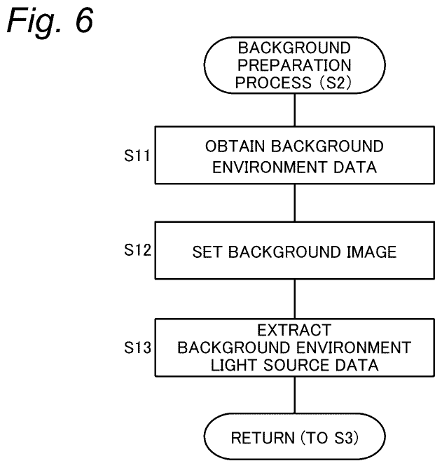

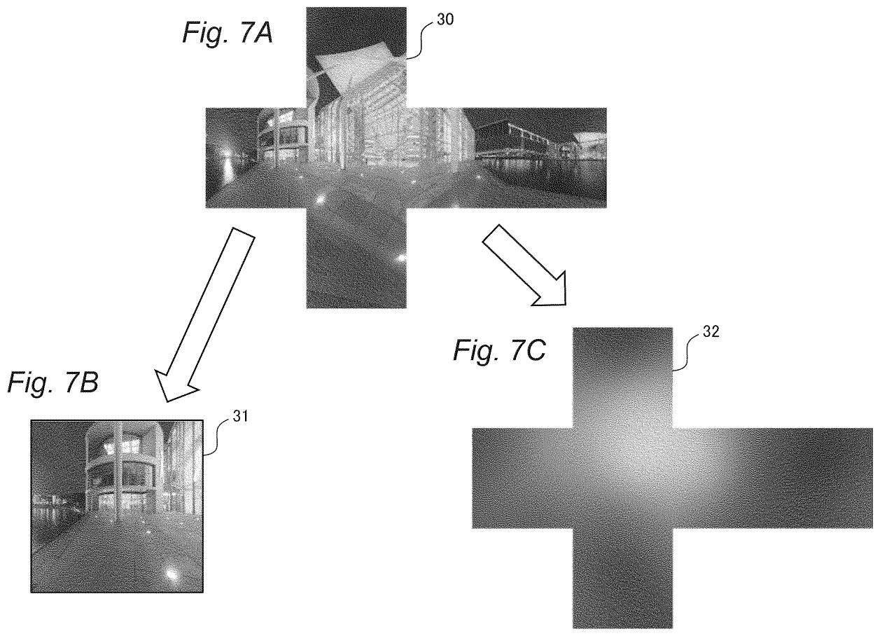

The details of the background preparation process in step S2 of FIG. 5 are explained using FIGS. 6 and 7.

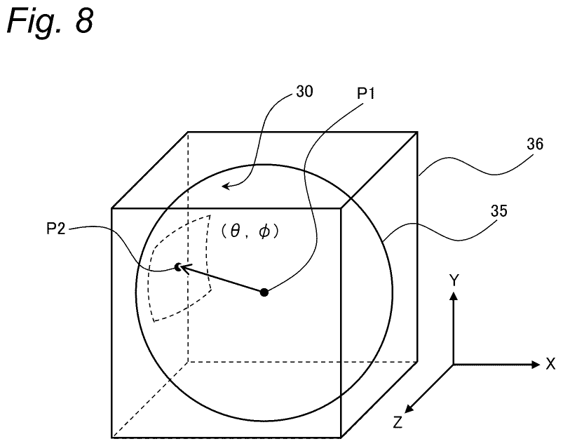

First, the controller 210 obtains image data showing the background environment corresponding to the surroundings of subject 20 in the new background after synthesis, for example (S11). Using FIGS. 7A and 8, the background environment data 30 obtained in step S11 will be described.

FIG. 7A illustrates background environment data 30 in the present system 10. FIG. 8 is a diagram explaining the background environment in the present system 10. FIG. 8 illustrates a predetermined subject position P1 in the three-dimensional space of the background environment, a celestial sphere 35 that surrounds the subject position P1 spherically in all directions (X, Y, Z) in the three-dimensional space, and a cube 36 that surrounds the celestial sphere 35. For example, the subject position P1 is predetermined to correspond to the position of the subject 20 after synthesis in the background environment.

For example shown in FIG. 8 and FIG. 7A, the background environment data 30 shows a panoramic image of the background environment extending in all directions from the subject position P1 to the celestial sphere 35. Such panoramic images of the background environment can be projected onto the inner surface of the celestial sphere 35 to associate each position of the celestial sphere 35 with each pixel of the background environment data 30, for example. For example, the background environment data 30 is configured in a cube map format, which is a omnidirectional image projected onto the inner walls of a sufficiently large cube 36 surrounding the subject position P1. The background environment data 30 is an example of the second image data in the present embodiment.

For example, the dynamic range of background environment data 30 may adopt high dynamic range (HDR). For example, the background environment data 30 may be created by performing HDR shooting with an omnidirectional camera or the like, in a real background environment. The background environment data 30 may indicate not only a real background environment but also a virtual background environment. The background environment data 30 may be composed of CG images created using computer graphics (CG) technology.

In the present system 10, the background environment data 30 can be stored in advance in a database managed by an image processing server 300, for example. In step S11, the controller 210 of the image editing terminal 200 accesses the image processing server 300 via a communication network, for example. Then, the controller 210 receives the background environment data 30 from the image processing server 300 via the communication interface 250 (S11).

Next, the controller 210 sets a background image indicating the background in the composite image 22 (FIG. 4B), based on the background environment data 30 (S12). The processing of step S12 is explained using FIG. 7B and FIG. 8.

FIG. 7B shows an example of a background image 31 set from the background environment data 30 in FIG. 7A. FIG. 8 shows an example of the field of view range corresponding to the background image 31 and its reference position P2 on the celestial sphere 35 corresponding to the omnidirectional image of the background environment data 30. The reference position P2 corresponds to the center position of the background image 31, for example.

In step S12, the controller 210 displays the omnidirectional image indicated by the background environment data 30 on the display 240, to receive user operation for the user to select the desired range from the omnidirectional image at the user interface 230, for example. Furthermore, the controller 210 extracts an image of the selected field of view range from, for example, the background environment data 30, performs projection transformation as necessary, and generates a background image 31 (S12).

Furthermore, the controller 210 extracts light source data of the background environment, based on the background environment data 30 (S13). The processing of step S13 is explained with reference to FIGS. 7C and 8.

FIG. 7C shows an example image of the background environment light source data 32 extracted from the background environment data 30 in FIG. 7A.

For the processing efficiency, the present system 10 adopts lowering of resolution for image-based lighting, which regards each pixel of the omnidirectional image of the background environment data 30 as a light source located on the celestial sphere 35 at infinity, for example. For example, the light source data 32 as shown in FIG. 7C, which is extracted from the background environment data 30 in FIG. 7A, can be encoded using basis functions such as spherical harmonics to decompose the background environment data 30, thereby compressing the data volume, as shown in Equation (1).

$$F ( θ , φ ) ≅ {\sum }_{l = 0}^{N} {\sum }_{m = - l}^{l} {F}_{l , m} {Y}_{l , m} ( θ , φ ) \qquad ( 1 )$$

In the above equation (1), F(θ, φ) on the left-hand side represents the omnidirectional image of the background environment data 30 for each RGB color. The spherical harmonic functions Y_{l,m}(θ, φ) on the right-hand side are defined by the angle position (θ, φ) as an argument and the indices (l, m) for identifying the basis functions. The angular position (θ, φ) corresponds to the position on the celestial sphere 35, and is defined with respect to a reference position P2, for example.

In equation (1), the SH coefficients F_{l,m} are the expansion coefficients of the spherical harmonic functions Y_{l,m}(θ, φ) corresponding to the indices (l, m) for the (color component F(θ, φ) of) omnidirectional image. The right-hand side of the above equation (1) represents the sum over the range of integer 1 from “0” to “N” and integer m from “−1” to “1” for the product of the spherical harmonic functions Y_{l,m}(θ, φ) corresponding to each index (l, m) and the SH coefficients F_{l,m}. “N” is a predetermined order, which is appropriately set based on considerations such as the accuracy of the approximation obtained by the above expansion (e.g., N=2).

In step S13, the controller 210 calculates the orthogonal expansion of the background environment data 30 using the spherical harmonic functions Y_{l,m}(θ, φ) of indices (l, m) of the predetermined order N or less, and calculates the corresponding SH coefficients F_{l,m}. For example, the controller 210 calculates a set of SH coefficients F_{l,m} (N≤2) composing of 9 (=1+3+5) components for each RGB color (i.e., a total of 27 components), as the light source data 32 (S13). According to the set of SH coefficients F_{l,m} of light source data 32, the corresponding spherical harmonic functions Y_{l,m}(θ, φ) can be used to restore the image of the light source as shown in FIG. 7C. Note that such cube map images are weighted by the solid angle corresponding to the projection relationship between the cube 36 and the celestial sphere 35 at each pixel for image-based lighting.

After extracting light source data 32 as described above (S13), the controller 210 completes the background preparation processing (S2) and proceeds to step S3 in FIG. 5.

According to the above background preparation process (S2), the present system 10 is capable of preparing a background image 31 to be synthesized and light source data 32 for such background environment based on the background environment data 30 (S12 to S13). The present system 10 is capable of preparing light source data 32 for a background environment that can reduce the processing load of lighting image processing, for example.

In the present system 10, the background environment data 30 is not limited to the cube map format, and may also be in an equirectangular format, a hyperdome master format, or a dome master format. The background environment data 30 may not be limited to omnidirectional images, but may also be images of, for example, a hemisphere or a panorama (i.e., the entire surroundings on a horizontal plane).

The obtaining of background environment data 30 (S11) is not limited to the image processing server 300, but may also be performed via appropriate data communication outside from the present system 10. Alternatively, the background environment data 30 may be stored in advance in the storage 221 of the image editing terminal 200, and in step S11, the controller 210 may read the background environment data 30 from the storage 221 into the temporary memory 222.

For example, in step S11, the subject position P1 (FIG. 8) in the background environment data 30 may be set by user operation. For example, the controller 210 may receive such user operation at the user interface 230. In step S12, the range in which the background image 31 can be set in the background environment data 30 may be restricted. For example, referring to the depth map corresponding to the shot image 21, the controller 210 may perform such range restrictions for allowing the addition of the natural shadow areas R1.

### 2.2.2. Image Synthesis Processing

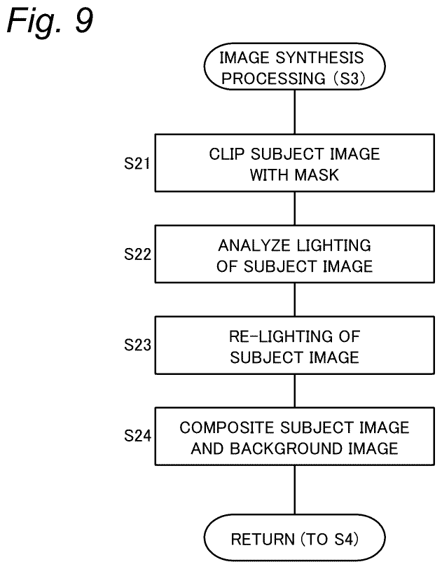

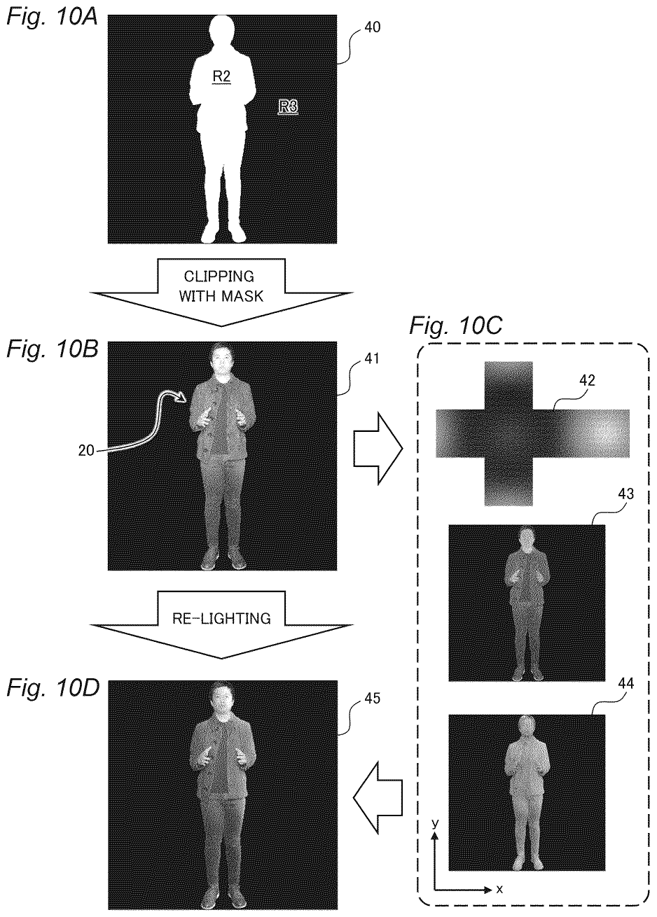

The details of the image synthesis process in step S3 of FIG. 5 are explained using FIGS. 9 to 10D.

First, the controller 210 extracts an image of the area to be synthesized from the shot image 21 (FIG. 4A) taken by the digital camera 100, for example (S21). The processing of step S21 is explained using FIGS. 10A and 10B.

FIG. 10A shows an example of a mask image 40 for the shot image 21 in FIG. 4A. FIG. 10B shows an example of a subject image 41 extracted from the shot image 21 in FIG. 4A using the mask image 40 in FIG. 10A. The mask image 40 includes a subject area R2 indicating the subject to be extracted in step S21 and a mask area R3 indicating the area outside the subject to be extracted in the shot image 21.

In step S21, the controller 210 first inputs the shot image 21 (FIG. 4A) into, for example, a pre-trained image segmentation model, and generates the mask image 40 as shown in FIG. 10A based on the output from the image segmentation model. The image segmentation model can be implemented using known techniques such as semantic segmentation and alpha matting (e.g., Document 1). For example, the image segmentation model is acquired by performing machine learning on deep neural networks (DNNs), including convolutional neural networks (CNNs) and deconvolutional neural networks (DCNNs), to determine the areas of an image where specified subjects, such as people, appear.

Furthermore, the controller 210 multiplies the generated mask image 40 (FIG. 10A) and the shot image 21 (FIG. 4A) pixel by pixel to generate the subject image 41 of the cropping result, as shown in FIG. 10B (S21). For example, the mask image 40 has a pixel value of “1” in the subject area R2 and a pixel value of “0” in the mask area R3. The mask image 40 may have an alpha value for partially translucently rendering the subject image 41 near the boundary of the subject area R2, for example. The image data of the subject image 41 may be an example of the first image data.

Next, the controller 210 analyzes various characteristics related to the lighting of the subject 20, based on the cut-out subject image 41, for example (S22). The processing in step S22 is performed as a preprocessing step for relighting (S23) the subject image 41, for removing the influence of the original lighting, such as the light source of the shooting environment, from the subject image 41. The processing in step S22 is explained with reference to FIG. 10C.

FIG. 10C shows examples of various analysis data 42 to 44 indicating the analysis results of the subject image 41 in FIG. 10B in step S22. For example, the analysis data 42 to 44 include light source data 42, an albedo map 43, and a light transport map 44 of the subject image 41.

The light source data 42 indicates the light source in the environment for the shot of the subject image 41 (and ultimately the shot image 21). The light source data 42 for the shooting environment is calculated as a set of SH coefficients having indices (1, m) of the predetermined order N or less, similar to the light source data 32 for the background environment (FIG. 7C).

The albedo map 43 has pixel values indicating the reflectance at each pixel position on the subject 20 in the subject image 41 by RGB color, for example. The albedo map 43 corresponds to an image showing the colors of the subject 20 after removing the effects of various environmental lighting conditions, such as the light source of the shooting environment, from the subject image 41.

The light transport map 44 shows, for each pixel, information on the transfer function that indicates the characteristics of the subject 20 in subject image 41 at various positions on the subject 20, wherein the characteristics cause the subject 20 to transfer reflected light in accordance with the incident light and reflectance. The transfer function includes information such as a visible function that indicates the normal direction at various positions on the subject 20 and availability for incident light arrived from a specific direction at that position to be incident. For example, the light transport map 44 has pixel values that encode the information of the transfer function as a set of SH coefficients (l, m) of the predetermined order N or less for each RGB.

According to the analysis data 42 to 44 shown above, the subject image 41 can be approximated as shown in equation (2), for example. This approximation is based on the assumption that mirror reflection is ignored, diffuse reflection is Lambertian reflection, and only low-frequency components are considered in image-based lighting.

$$G ( x , y ) ≅ ρ ( x , y ) {\sum }_{l = 0}^{N} {\sum }_{m = - l}^{l} {G}_{l , m} {T}_{l , m} ( x , y ) \qquad ( 2 )$$

In the above equation (2), the image coordinates (x, y) indicate the pixel position, and G(x, y) on the left-hand side indicates the color component of the subject image 41. On the right-hand side of equation (2), the sum is taken for the products of the SH coefficients G_{l,m} of the light source data 42 and the SH coefficients T_{l,m} of the light transport map 44 within the range of the specified order N (i.e., 1=0 to N and m=−1 to 1) with common indices (l, m), and then the reflectance ρ(x, y) in the albedo map 43 is multiplied for each pixel.

In step S22, the controller 210 inputs the subject image 41 (FIG. 4B) into, for example, a predetermined machine learning-based estimation model, and generates the above-mentioned analysis data 42 to 44 based on the output of the estimation model. Such an estimation model can be realized by applying appropriate known technologies (see, e.g., Document 2).

For example, the estimation model in step S22 comprises a DNN that includes an encoder such as a CNN that inputs subject image 41, a CNN that estimates light source data 42, and a decoder that estimates the respective maps 43 and 44 using a DCNN or the like. The machine learning of the estimation model is performed such that the various analysis data 42 to 44 generated from input images of specific subjects, such as subject image 41, improve the accuracy of reproducing the input images according to equation (2).

Next, the controller 210 performs image processing for relighting to adjust the brightness of the subject image 41, based on the analysis results (S22) of the subject image 41 and the light source data 32 of the new background environment (FIG. 7C) (S23). Step S23 is explained using FIG. 10D.

FIG. 10D shows an example of a re-lit image 45 obtained by performing the re-lighting process (S23) on the subject image 41 shown in FIG. 10B. In step S23, the controller 210 performs the calculation of equation (2) similar to the above but using the light source data 32 of the background environment instead of the light source data 42 of the shooting environment. As a result, the controller 210 can generate the relighting image 45 with brightness adjusted to match the light source data 32 of the background environment, as shown in FIG. 10D (S23).

Next, based on the re-lit image 45 of the subject 20 obtained in this manner and the background image 31 (FIG. 7B) obtained in the background preparation process (S2), the controller 210 generates the composite image 22 as shown in FIG. 4B (S24).

For example, in step S24, the controller 210 superimposes the relighting image 45 layer on the background image 31 and aligns the subject image 41 appropriately on the background image 31. With this superimposition (S24), the controller 210 composites the relighting image 45 and the background image 31 such that the background image 31 is adopted in the range corresponding to the outside of the subject area R2 in the mask image 40 (FIG. 10A). In the image synthesis of step S24, when an alpha value is set for the mask image 40, the background image 31 may be partially visible through the subject image 41 by alpha blending.

In this way, the controller 210 completes the image synthesis processing (S3) shown in FIG. 9 by generating the composite image 22 (S23) and proceeds to step S4 in FIG. 5.

According to the above image synthesis process (S3), the present system 10 can adjust the brightness of the subject image 41 as a whole to match the background image 31 by re-lighting (S23) for generating the composite image 22 of the subject image 41 and the background image 31 (S23).

The above description has explained an example of the process (S22) of analyzing the subject image 41 for re-lighting (S23), but the present system 10 is not limited to this. For example, for the estimation model described above, the estimation of the light source data 42 may be performed only during machine learning, and may be omitted in step S22. In the present system 10, the estimation model for re-lighting (S23) is not limited to the above example, and various models may be adopted.

For example, in step S22, the controller 210 may estimate depth map and normal map from the subject image 41 instead of using the various analysis data 42 to 44 mentioned above. Also, in step S23, the controller 210 may generate the re-lit image 45 using a trained model or the like, instead of performing the calculation in equation (2) above.

In addition, the physical modeling of re-lighting may consider not only Lambertian reflection but also various diffuse or non-diffuse reflections, and may also consider specular reflection using models such as the Phong reflection model (Documents 1, 2, and the like). The re-lighting process (S23) in the image synthesis processing (S3) does not necessarily require a reduction in processing load, and various re-lighting techniques may be appropriately adopted depending on the required image quality accuracy and other factors.

### 2.2.3. Shadow Correction Processing

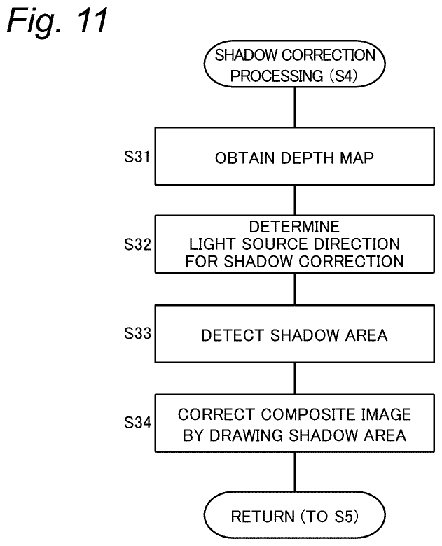

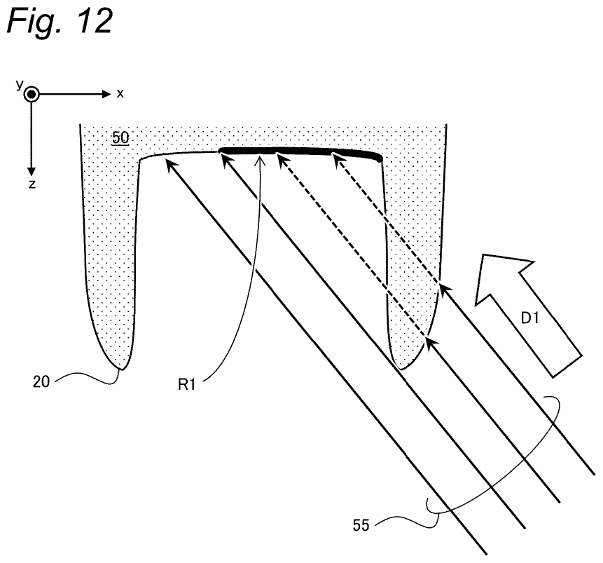

The details of the shadow correction process in step S4 of FIG. 5 are explained using FIGS. 11 to 12.

First, the controller 210 obtains information such as a depth map related to the shape of the subject 20 (S31). The depth map in step S31 is an example of subject information in the present embodiment.

For example, in step S31, the controller 210 reads a depth map corresponding to the shot image 21 (FIG. 4A) by referring to the meta information in the image data of the shot image 21 from the digital camera 100. Furthermore, the controller 210 extracts the depth map corresponding to the subject area R2 from the depth map corresponding to the shot image 21 by clipping with the mask image 40, as in step S21 of FIG. 9 (S31).

Based on the background environment light source data 32 (FIG. 7C), the controller 210 determines the light source direction to be used for reflecting shadows, for example (S32). The processing in step S32 is performed to narrow down the light sources to be considered for shadow correction from the viewpoint of clarifying the shadows formed by the subject 20 or reducing the processing load for reflecting shadows.

For example, in step S32, the controller 210 extracts pixels with a predetermined high light intensity from the image of the background environment light source data 32, and determines the light source direction for the shadow reflection, based on the angle positions (θ, φ) corresponding to the extracted pixels. The predetermined high light intensity may be a light intensity that indicates a standard for light sources that are expected to form shadows, the highest light intensity in the background environment, or a locally peaked light intensity. Such light intensity may be obtained, in the case of a cube map as an example, by appropriately weighting the solid angle with respect to the brightness value of the pixels.

Next, the controller 210 detects shadow regions R1 (FIG. 4C) that are expected to be generated by light obstruction on the subject 20, based on the depth map obtained in step S31 and the light source direction determined in step S32 (S33). The processing of step S33 is explained using FIG. 12.

FIG. 12 is a diagram illustrating the shadow correction process (S4) of the present embodiment. FIG. 12 shows an example of a shadow region R1 formed by the depth map 50 of step S31 and the light source direction D1 of step S32. For example, the depth map 50 of step S31 includes the depth z of the subject 20 in view from the digital camera 100 at the time of shooting as pixel values.

In the present system 10, the shadow region R1 is formed, for example as shown in FIG. 12, on the extension line of the light ray 55 that is incident from the light source direction D1 onto the surface of the subject 20 and is blocked. In step S33, the controller 210 detects a set of pixels located on the extension line of light rays 55 incident from the light source direction D1 onto the subject 20, as shown in the relit composite image 22 (FIG. 4B), as the shadow region R1.

The detection of shadow region R1 (S33) can be performed using various methods, such as ray tracing, depth shadowing, or shadow volume methods. The processing in step S33 may also use a depth map, i.e., a shadow map, as viewed from the light source direction D1. For example, the controller 210 may calculate the shadow map by performing coordinate transformation according to triangulation with respect to the depth map 50 at the time of shooting. In such a shadow map, shadow region R1 overlaps the obscured portion on subject 20, and the depth of the obscuring portion is stored at the position of shadow region R1. The controller 210 may detect shadow region R1 based on the depth difference in the shadow map (S33).

Next, the controller 210 generates image data indicating the corrected result by correcting the composite image 22 generated by the image synthesis process (S3) to include the shadow area R1, based on the shadow area R1 detected in this manner, for example as shown in FIGS. 4B and 4C (S34).

For example, in step S34, the controller 210 generates a composite image 23 of the correction result, as shown in FIG. 4C, by drawing the detected shadow area R1 in the composite image 22 shown in FIG. 4B. For example, the shadow area R1 can be drawn by darkening the pixel values of each pixel located in the shadow area R1 in the composite image 22. In this way, the controller 210 adds the shadow region R1 to the composite image 22 to generate image data showing the shadow-corrected composite image 23 (S34). The image data in step S34 is an example of composite image data in the present embodiment.

The controller 210 generates image data for the composite image 23 of the correction results (S34), terminates the shadow correction process (S4) shown in FIG. 11, and proceeds to step S5 in FIG. 5, for example.

According to the above shadow correction processing (S4), the present system 10 generates image data of shadow correction results so as to include shadow area R1 caused by the obstruction of light from the light source direction D1 of the background environment in the composite image 23, based on the light source data 32 of the background environment, for example (S34). As a result, the present system 10 can easily obtain natural shadows in the corrected composite image 23 (FIG. 4C) by reflecting the shadow area R1 caused by the light source of the background environment in the relit composite image 22 (FIG. 4B) that is adapted to the background environment.

In the present system 10, according to the depth map 50 as seen from the digital camera 100, it is possible to detect the shadow area R1, i.e., the self-shadow, falling on the subject 20 in accordance with the shape of the subject 20 (S33). The shadow area R1 in the present system 10 is not limited to this, but may also be a cast shadow formed on the background image 31, for example.

For example, in step S31, the controller 210 may obtain a depth map of the background environment in addition to the depth map 50 of the subject 20. For example, the present system 10 may manage information indicating the depth of the background environment in a database of background environment data 30, and the processing of step S31 may be performed by referring to such a database. In step S33, the controller 210 can further use the background environment depth map to detect shadow areas where the subject 20 blocks light from reaching the background to cast shadows on the background, and can correct the composite image 22 to include such shadow areas (S34).

The obtaining of depth map 50 of subject 20 (S31) is not limited to the above example, but may be performed by the controller 210, which performs estimation processing of the depth map 50. Such estimation processing of the depth map 50 may be performed by analyzing the subject image 41 using a trained model, or by using various information obtained at the image shooting by digital camera 100. For example, in the digital camera 100, various information such as image plane phase detection information or bokeh information may be included in the metadata of the image data, and the controller 210 may perform the same processing as the depth measurer 122, based on such metadata.

In the present system 10, the depth map estimation process described above is not limited to the depth map 50 of the subject 20 in view from the digital camera 100. For example, the controller 210 may generate a depth map viewed from the light source direction D1 or a depth map of the background environment using a trained model of such estimation process. In the present system 10, the depth map estimation process may use multiple frame images or image recognition of the subject 20. For example, the controller 210 may interpolate the depth of the subject 20 that is in the blind spot in one frame using the estimation results from other frame images.

In the above shadow correction process (S4), the determination of the light source direction D1 (S32) may be performed using the background environment data 30 alternatively or additionally to the background environment light source data 32. The processing in step S32 may be performed in the background preparation process (S2). The light source direction D1 for the shadow reflection in step S32 is an example of light source information for the background environment. Such light source directions D1 for the shadow reflection may be in single direction or in multiple directions. In the shadow correction process (S4) of the present system 10, higher-order SH coefficients F_{l,m} (e.g., N=5, 36 for each color) may be used for determining the light source direction D1 (S32) than in the relighting process, for example (S23). This allows the diffuse light during relighting to be sufficiently reproduced even at lower dimensions, thereby reducing processing load with improving the reproducibility of hard shadows by the shadowing. As described above, in the present system 10, the accuracy of light source information may be varied between relighting and shadowing, taking into account processing load and computational requirements.

In the above description, the light rays 55 parallel to the light source direction D1 are used in the detection of shadow area R1 (S33). The present system 10 is not limited to such parallel light sources, and may detect shadow region R1 even when various light sources, such as point light sources, spot light sources, or area light sources, are arranged in the background environment (S33). The controller 210 can generate image data of the correction result so that the shadow region R1 formed by such various light sources is included in the composite image 23 in the same manner as in the above example (S34).

Also, in the detection of shadow area R1 (S33), when the shape of shadow area R1 is unknown due to blind spots in the depth map of subject 20, the controller 210 may draw shadow area R1 by appropriately interpolating or estimating its shape (S34). Alternatively, the controller 210 may perform drawing such as blurring a part or all of the contour of shadow region R1 (S34).

In the present system 10, the processing (S33, S34) for detecting and drawing the shadow region R1 may be performed separately or simultaneously. The controller 210 may adjust the pixel value according to whether or not the pixel corresponds to the shadow region R1 at the time of drawing each pixel. Various techniques, such as ambient occlusion or screen-based ambient occlusion, may be applied to the shadow correction processing (S4) of the present system 10.

### 3. Review

As described above, in the imaging system 10 of the present embodiment, the image editing terminal 200 as an example of the image processing device includes the communication interface 250 as an example of an input interface, and the controller 210. The communication interface 250 inputs image data of the shot image 21 as an example of the first image data indicating the subject image shot by the digital camera 100, which is an example of the imaging apparatus (S1). The controller 210 generates composite image data in which the subject image 41 and the background image 31 are synthesized, based on the first image data input to the communication interface 250 and background environment data 30, which is an example of second image data indicating a predetermined background image 31. The controller 210 obtains light source data 30, which is an example of light source information indicating the light source in the background image 31, based on the second image data (S2). The controller 210 generates composite image data including a shadow region R1 indicating a shadow corresponding to the light source indicated by the subject 20 in the subject image 41 in the composite image 23 in which the subject image 41 is placed on the background image 31, based on the light source information in the background image 31 (S4).

According to the above image editing device 200, the shadow area R1 based on the light source information of background image 31 is included in composite image 23, it can facilitate obtaining natural shadows in the image synthesis of the shot subject 20 and the background.

In the present system 10, the controller 210 performs a relighting process to adjust the brightness in the subject image 41 in accordance with the light source data 32 of the background image 31 (S23). The controller 210 generates composite image data by correcting (or retouching) the composite image 22, which has had its brightness adjusted based on the light source direction D1 in the light source information of the background image 31, to include the shadow area R1 (S4). As a result, the present system 10 can easily obtain natural shadows in the composite image 23 by including the shadow area R1 in addition to relighting according to the background environment.

In the present system 10, the controller 210 adjusts the overall brightness of the subject image 41 by relighting according to the light source information of the background environment (S23), and corrects the composite image 22 so that the composite image 22 includes a shadow area R1 in a part of the subject image 41 (S4). By doing so, as the local shadows of the subject 20 are corrected separately, the processing load of the relighting process, which adjusts the entire image of the subject 20, can be reduced. Thus, the present system 10 can make it easier to obtain natural shadows in the composite image 23. For example, the relighting process (S23) may be performed at a lower resolution than the background image 31, and the shadow correction process (S4) may be performed at a higher resolution than the relighting process (S23).

In the present system 10, the controller 210 obtains a depth map 50, which is an example of subject information indicating the shape of the subject 20 shown by the subject image 41 (S31). The controller 210 generates composite image data in the composite image 22, including a shadow region R1 that reflects the shape of the subject 20, based on the light source information of the background image 31 and the subject information (S34). As a result, the present system 10 can easily obtain natural shadows in the composite image 23 using subject information such as the depth map 50.

In the present system 10, the digital camera 100 generates a depth map 50 associated with the first image data when shooting the subject image 41. The controller 210 obtains subject information from the digital camera 100, for example via the communication interface 250. As a result, the present system 10 can utilize the information obtained during shooting by the digital camera 100 to facilitate the creation of natural shadows in the composite image 23.

In the present system 10, the background image 31 includes at least one of an image of a real background and a computer graphics image. The present system 10 can easily obtain natural shadows in image synthesis with such background images 31.

In the present system 10, the communication interface 250 of the image editing terminal 200 receives the first image data via data communication with an external storage device such as a digital camera 100, a memory card 142, or an image processing server 300 (S1). The present system 10 can facilitate obtaining natural shadows in the composite image 23 when the image editing terminal 200 performs image synthesis on the received image data.

In the present embodiment, we provide an image processing method executed by a computer such as an image editing terminal 200. The method includes a step (S1) of inputting first image data showing a subject image 41 shot by a digital camera 100, a step (S13) of obtaining light source information indicating light sources in a background image 31 based on second image data showing the background image 31, and a step (S4) of generating composite image data by synthesizing the subject image 41 and the background image 31, including a shadow area R1 showing shadows corresponding to light sources in the background image 31, based on the light source information obtained in step (S13). The shadow region R1 corresponds to the light source indicated by the subject in the subject image 41, thereby generating composite image data in which the subject image 41 and the background image 31 are synthesized. According to the present method, it is possible to facilitate obtaining natural shadows in the image synthesis of the shot subject 20 and the background.

In the present embodiment, a program to be executed by a processor such as the controller 210 of the image editing terminal 200 is provided. This program includes a step (S1) of inputting image data showing a subject image 41 shot by a digital camera 100, a step (S12) of setting a background image 31 corresponding to a predetermined light source, and a step of obtaining composite image data in which the subject image 41 is placed on the background image 31 in a composite image, the subject image 41 and the background image 31 are synthesized to obtain composite image data including a shadow area R1 corresponding to the light source indicated by the subject in the subject image 41 (S4). According to this program, it can facilitate obtaining natural shadows in the image synthesis of the shot subject 20 and the background.

### OTHER EMBODIMENTS

As the above, the first embodiment has been described as an example of the techniques disclosed in the present application. However, the technique in the present disclosure is not limited thereto, and can also be applied to embodiments in which change, replacement, addition, omission, and the like are made as appropriate. Each of the constituents described in the embodiment can be combined to form a new embodiment. Other embodiments will be described below.

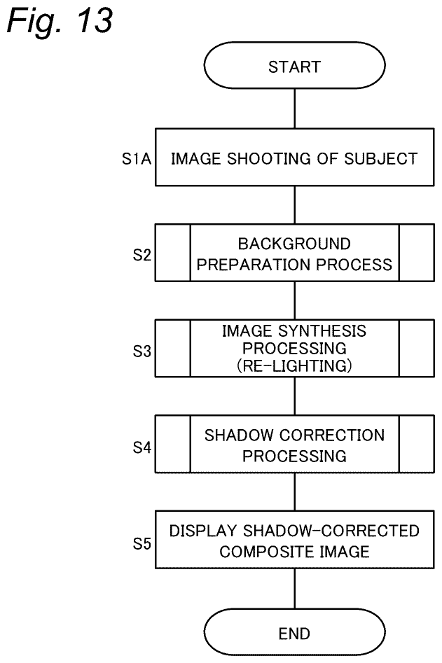

In the above-described the first embodiment, the imaging system 10 with the image editing terminal 200 as an example of an image processing device has been described, but the present disclosure is not limited thereto. Such modified examples will be described with reference to FIG. 13.

FIG. 13 is a flowchart illustrating the operation of the imaging system 10 of the modified example. In this modified example, the image processing device may be integrally configured with the digital camera 100. Additionally, the present system 10 may not necessarily include the image editing terminal 200. For example, in the digital camera 100 of the present embodiment (FIG. 2), the image processing engine 120 and the controller 135 may constitute an image processing device. For example, the processing illustrated in FIG. 13 is executed by the controller 135 of the digital camera 100 controlling the image processing engine 120 and others.

In the imaging system 10 of the first embodiment, the image data of the shooting results of the digital camera 100 is input to the image editing terminal 200 (S1). In the present embodiment, instead of step S1, as shown in FIG. 13, the controller 135 causes the image sensor 115 in the digital camera 100 to perform imaging operations and execute image shooting operations of the subject 20, for example (SIA). The controller 135 stores the image data of the shot image in a buffer memory 125 as appropriate, inputs it into the image processing engine 120, and performs the processing of steps S2 to S5 in the same manner as in the first embodiment. For example, the shadow-corrected composite image 22 is displayed on the display monitor 130 of the digital camera 100 (S5). For example, the user of the digital camera 100 can confirm the composite image 23 in real time during image shooting.

As described above, in the present embodiment, the digital camera 100, which is an example of an imaging apparatus, includes an image sensor 115, which is an example of an image sensor, and an image processing device comprising an image processing engine 120 and a controller 135. The image processing engine 120 and the controller 135 function as the input interface and the controller of the image processing device, respectively, and generate composite image data based on the image data generated by the image sensor 115 (SIA to S4). As a result, similar to the first embodiment, it is possible to facilitate obtaining natural shadows in the image synthesis of the shot subject 20 and the background.

In the present embodiment, the processing of steps S2 to S4 in FIG. 13 may be performed not only within the digital camera 100 but also, for example, via data communication with an image processing server 300. For example, the digital camera 100 may transmit image data of the shooting results or the like, to the image processing server 300 via the communication module 155 and receive data of the processing results from the image processing server 300 in response thereto. For example, the image processing server 300 may execute some or all of the background preparation processing (S2), image synthesis processing (S3), and shadow correction processing (S4), and generate image data of the shadow-corrected composite image 23.

In the present embodiment, not limited to the digital camera 100, the image editing terminal 200 may also perform the processing of steps S2 to S4 in FIG. 5 by data communication with the image processing server 300 in the same manner as above. That is, the digital camera 100 or the image editing terminal 200 may obtain the composite image data through data communication with the image processing server 300 or through internal processing in response to the input of the image data of the shooting result. This also enables the same natural shading as in the above embodiments to be easily achieved in the image synthesis of the shot subject 20 and the background.

As described above, the image processing device in the present embodiment may be implemented as a network-type system constructed by data communication between the image editing terminal 200 or the digital camera 100 and the image processing server 300. In the present embodiment, a program to be executed on the terminal, such as the image editing terminal 200 or digital camera 100, may be provided. Alternatively, the image processing server may be an example of the image processing device in the present embodiment.

In the above embodiments, the imaging system 10 in which image synthesis processing (S3) and shadow correction processing (S4) are sequentially executed has been described, but the present disclosure is not limited thereto. For example, in the present embodiment, image synthesis processing (S3) and shadow correction processing (S4) may be executed integrally. In the present embodiment, the re-lit and shadow-corrected composite image 22 need not necessarily be generated. The present system 10 may omit such intermediate generation and generate the shadow-corrected composite image 23 directly.

In the above embodiments, the imaging system 10 that performs the re-lighting process (S23) in the image synthesis process (S3) has been described. In the present embodiment, the relighting process (S23) may not necessarily be performed. For example, when the desired naturalness is able to be obtained by simply adding shadow areas R1 corresponding to the light source information of the background environment to the composite image without performing relighting, the various processes (S22 to S23) for relighting may be omitted as appropriate.

In the above embodiments, the virtual production has been cited as an example of the application of the imaging system 10, but the present disclosure is not limited thereto. For example, the present system 10 may be applied to various video production applications not limited to the virtual production, or may be applied to background synthesis applications such as web conferencing. The subject 20 of the present system 10 may be the user of the digital camera 100.

In the above embodiments, the display monitor 130 is shown as an example of the display of the digital camera 100. In the digital camera 100 of the present embodiment, the display is not limited to the display monitor 130, but may also be, for example, an EVF (electronic viewfinder) or an output module that outputs video signals in accordance with the HDMI standard.

In the above embodiments, the digital camera 100 equipped with the optical system 110 is illustrated as an example. The imaging apparatus of the present embodiment may not necessarily be equipped with the optical system 110, and may be an interchangeable lens camera, for example.

In the above embodiments, the digital camera has been described as an example of the imaging apparatus, but this is not limited thereto. The imaging apparatus of the present disclosure may be any electronic device having an image shooting function (e.g., a video camera, a smartphone, a tablet device, or the like). The image processing device of the present disclosure may be any of the above electronic devices, or may be an electronic device that does not have the image shooting function.

### ASPECT EXAMPLES

Hereinafter, various aspects of the present disclosure will be exemplified.

A first aspect according to the present disclosure is an image processing device including: an input interface configured to input a first image data indicating a subject image shot by an imaging apparatus; and a controller configured to generate composite image data, based on the first image data input on the input interface and second image data indicating a predetermined background image, the composite image data synthesized from the subject image and the background image. The controller is configured to: obtain light source information, based on the second image data, the light source information indicating light source in the background image; and generate the composite image data to include a shadow area into a composite image in which the subject image is placed on the background image, based on the light source information on the background image, the shadow area showing a shadow corresponding to a subject indicated by the subject image in accordance with the light source.

A second aspect is the image processing device according to the first aspect, wherein the controller is configured to: adjust brightness of the subject image according to the light source information of the background image; and generate the composite image data by correcting the composite image, in which the brightness of the subject image has been adjusted, to include the shadow area, based on the light source information of the background image.

A third aspect is the image processing device according to the first or second aspect, wherein the controller is configured to: adjust the brightness as a whole of the subject image according to the light source information; and correct the composite image to include the shadow area in a portion of the subject image in the composite image.

A fourth aspect is the image processing device according to any one of the first to third aspects, wherein the controller is configured to: obtain subject information indicating a shape of the subject indicated by the subject image; and generate the composite image data to include the shadow area with reflecting the shape of the subject in the composite image, based on the light source information of the background image and the subject information.

A fifth aspect is the image processing device according the fourth aspect, wherein the imaging apparatus is configured to generate the subject information associated with the first image data, when the subject image is shot. The controller is configured to obtain the subject information from the imaging apparatus.

A sixth aspect is the image processing device according to any one of the first to fifth aspects, wherein the background image includes at least one of an image shot in a real background or an image made with computer graphics.

A seventh aspect is the image processing device according to any one of the first to sixth aspects, wherein the input interface is configured to receive the first image data via data communication with the imaging apparatus or external storage device.

An eighth aspect is an imaging apparatus including: an image sensor configured to capture an image of the subject to generate the first image data, and the image processing device according to any one of the first to sixth aspects, the image processing device configured to generate the composite image data, based on the first image data generated by the image sensor.

A ninth aspect is an image processing method executed by a computer. The method, includes: inputting first image data indicating subject image shot by an imaging apparatus, and obtaining light source information, based on second image data indicating a predetermined background image, the light source information indicating light source in the background image, and generating composite image data to include a shadow area into a composite image in which the subject image is placed on the background image, based on the light source information on the background image, the composite image data synthesized from the subject image and the background image, the shadow area showing a shadow corresponding to a subject indicated by the subject image in accordance with the light source.

A tenth aspect is a non-transitory computer-readable recording medium storing a program for causing a processor of a computer. The program includes: inputting image data indicating a subject image shot by an imaging apparatus, setting a background image corresponding to a predetermined light source, and obtaining composite image data in accordance with the input image data, the composite image data synthesized from the subject image and the background image to include a shadow area into a composite image in which the subject image is placed on the background image, the shadow area showing a shadow corresponding to a subject indicated by the subject image in accordance with the light source.

As described above, the embodiments have been described as examples of the techniques in the present disclosure. To that end, the accompanying drawings and detailed description thereof have been provided. Therefore, the constituents described in the accompanying drawings and the detailed description may include not only constituents essential for achieving an object of the present disclosure but also constituents not essential for achieving it, for the purpose of exemplifying the above techniques. Thus, those non-essential constituents should not be immediately recognized as essential by the fact that those non-essential constituents are described in the accompanying drawings or in the detailed description. With the above embodiments being intended to illustrate the techniques in the present disclosure, various modifications, substitutions, additions, omissions, and the like can be made within the scope of the claims or the equivalents thereto.

The present disclosure is applicable to various applications for synthesizing background and subject images.

1. An image processing device comprising:
an input interface configured to input a first image data indicating a subject image shot by an imaging apparatus; and
a controller configured to generate composite image data, based on the first image data input on the input interface and second image data indicating a predetermined background image, the composite image data synthesized from the subject image and the background image,
wherein the controller is configured to:
obtain light source information, based on the second image data, the light source information indicating light source in the background image; and
generate the composite image data to include a shadow area into a composite image in which the subject image is placed on the background image, based on the light source information on the background image, the shadow area showing a shadow corresponding to a subject indicated by the subject image in accordance with the light source.

2. The image processing device according to claim 1,
wherein the controller is configured to:
adjust brightness of the subject image according to the light source information of the background image; and
generate the composite image data by correcting the composite image, in which the brightness of the subject image has been adjusted, to include the shadow area, based on the light source information of the background image.

3. The image processing device according to claim 2,
wherein the controller is configured to:
adjust the brightness as a whole of the subject image according to the light source information; and
correct the composite image to include the shadow area in a portion of the subject image in the composite image.

4. The image processing device according to claim 1,
wherein the controller is configured to:
obtain subject information indicating a shape of the subject indicated by the subject image; and
generate the composite image data to include the shadow area with reflecting the shape of the subject in the composite image, based on the light source information of the background image and the subject information.

5. The image processing device according to claim 4,
wherein the imaging apparatus is configured to generate the subject information associated with the first image data, when the subject image is shot, and
the controller is configured to obtain the subject information from the imaging apparatus.

6. The image processing device according to claim 1,
wherein the background image includes at least one of an image shot in a real background or an image made with computer graphics.

7. The image processing device according to claim 1,
wherein the input interface is configured to receive the first image data via data communication with the imaging apparatus or external storage device.

8. An imaging apparatus comprising:
an image sensor configured to capture an image of the subject to generate the first image data, and
the image processing device according to claim 1, the image processing device configured to generate the composite image data, based on the first image data generated by the image sensor.

9. An image processing method executed by a computer, comprising:
inputting first image data indicating subject image shot by an imaging apparatus, and
obtaining light source information, based on second image data indicating a predetermined background image, the light source information indicating light source in the background image, and
generating composite image data to include a shadow area into a composite image in which the subject image is placed on the background image, based on the light source information on the background image, the composite image data synthesized from the subject image and the background image, the shadow area showing a shadow corresponding to a subject indicated by the subject image in accordance with the light source.

10. A non-transitory computer-readable recording medium storing a program for causing a processor of a computer, the program comprising:
inputting image data indicating a subject image shot by an imaging apparatus,
setting a background image corresponding to a predetermined light source, and
obtaining composite image data in accordance with the input image data, the composite image data synthesized from the subject image and the background image to include a shadow area into a composite image in which the subject image is placed on the background image, the shadow area showing a shadow corresponding to a subject indicated by the subject image in accordance with the light source.
